(19) United States
(12) Patent Application Publication
(10) Pub. No.: US 2025/0193003 A1
(43) Pub. Date: Jun. 12, 2025

(54) COMMUNICATION CONTROL DEVICE, COMMUNICATION DEVICE, COMMUNICATION CONTROL SYSTEM, COMMUNICATION CONTROL METHOD, AND PROGRAM

(71) Applicant: NEC Corporation, Minato-ku, Tokyo (JP)

(72) Inventor: Yuta OTSUKA, Tokyo (JP)

(73) Assignee: NEC Corporation, Minato-ku, Tokyo (JP)

(21) Appl. No.: 18/843,750

(22) PCT Filed: Mar. 15, 2022
(86) PCT No.: PCT/JP2022/011516

§ 371 Date: Sep. 4, 2024

(51) Int. Cl. H04L 9/08; H04L 9/40

(52) U.S. Cl. CPC H04L 9/088; H04L 63/0428

(57) ABSTRACT

In order to make it possible to suitably instruct encryption or decryption of information according to the security level, a communication control apparatus (1) includes: an acquisition means (11) for acquiring communication path information; and an instruction means (12) for instructing at least one of encryption and decryption of a target flow with use of an encryption range which is defined according to the acquired communication path information and which is of the target flow.

### TECHNICAL FIELD

The present invention relates to a communication control apparatus, a communication apparatus, a communication control system, a communication control method, and a program.

### BACKGROUND ART

In recent years, it has become common that a plurality of information processing apparatuses are connected via a relay apparatus so as to construct a network. Thus, the security risks between the apparatuses have increased. As related technologies, there are the inventions disclosed in Patent Literatures 1 and 2 below.

Patent Literature 1 discloses that, when an information processing apparatus stores, in an information management apparatus, information including a plurality of items with different security levels, the encryption level of the information can be varied based on a predetermined degree of reliability.

Patent Literature 2 discloses monitoring the state of a communication section, acquiring quality information that identifies the current communication state, deciding the encryption level based on the quality information acquired, and encrypting the transmission data based on the decided encryption level.

### CITATION LIST

### Patent Literature

[Patent Literature 1]
Japanese Patent Application Publication, Tokukai, No. 2006-157883
[Patent Literature 2]
Japanese Patent Application Publication, Tokukai, No. 2004-064652

### SUMMARY OF INVENTION

### Technical Problem

Patent Literature 1 discloses that the information processing apparatus can vary the encryption level of information according to a predetermined degree of reliability. However, merely allowing the encryption level to be varied may not suitably encrypt information according to the security level.

Patent Literature 2 discloses deciding the encryption level based on quality information that identifies the current communication state. However, similarly to Patent Literature 1, merely changing the encryption level may not suitably encrypt the information according to the security level.

An example aspect of the present invention has been made in view of the above problems, and an example object thereof is to provide a technique for making it possible to suitably encrypt information according to a security level.

### Solution to Problem

A communication control apparatus in accordance with an example aspect of the present invention includes: an acquisition means for acquiring communication path information; and an instruction means for instructing at least one of encryption and decryption of a target flow with use of an encryption range which is defined according to the communication path information acquired and which is of the target flow.

A communication apparatus in accordance with an example aspect of the present invention includes: an acquisition means for acquiring communication path information; and an execution means for executing at least one of encryption and decryption of a target flow with use of an encryption range which is defined according to the communication path information acquired and which is of the target flow.

A communication control system in accordance with example aspect of the present invention includes: an acquisition means for acquiring communication path information; an instruction means for instructing at least one of encryption and decryption of a target flow with use of an encryption range which is defined according to the communication path information acquired and which is of the target flow; and an execution means for executing at least one of encryption and decryption of the target flow with use of the encryption range of the target flow.

A communication control method in accordance with an example aspect of the present invention includes: acquiring communication path information; and instructing at least one of encryption and decryption of a target flow with use of an encryption range which is defined according to the communication path information acquired and which is of the target flow.

A communication control method in accordance with an example aspect of the present invention includes: acquiring communication path information; and executing at least one of encryption and decryption of a target flow with use of an encryption range which is defined according to the communication path information acquired and which is of the target flow.

A program in accordance with an example aspect of the present invention causes a computer to execute: a process of acquiring communication path information; and a process of instructing at least one of encryption and decryption of a target flow with use of an encryption range which is defined according to the communication path information acquired 20 and which is of the target flow.

A program in accordance with an example aspect of the present invention causes a computer to execute: a process of acquiring communication path information; and a process of executing at least one of encryption and decryption of a target flow with use of an encryption range which is defined according to the communication path information acquired and which is of the target flow.

### Advantageous Effects of Invention

With an example aspect of the present invention, it is possible to suitably encrypt information according to a security level.

### BRIEF DESCRIPTION OF DRAWINGS

FIG. 1 is a block diagram illustrating an example configuration of a communication control apparatus in accordance with a first example embodiment of the present invention.

FIG. 2 is a flowchart illustrating a flow of a communication control method carried out by the communication control apparatus in accordance with the first example embodiment of the present invention.

FIG. 3 is a block diagram illustrating an example configuration of a communication apparatus in accordance with the first example embodiment of the present invention.

FIG. 4 is a flowchart illustrating a flow of a communication control method carried out by the communication apparatus in accordance with the first example embodiment of the present invention.

FIG. 5 is a block diagram illustrating an example configuration of a communication control system in accordance with the first example embodiment of the present invention.

FIG. 6 is a block diagram illustrating an example configuration of a communication control apparatus and a communication apparatus in accordance with a second example embodiment of the present invention.

FIG. 7 is a diagram schematically illustrating connections between the communication control apparatus and the communication apparatus in accordance with the second example embodiment of the present invention.

FIG. 8 is a diagram illustrating an example of an encryption range of a packet.

FIG. 9 is a diagram schematically illustrating a trust score between the communication apparatuses.

FIG. 10 is a diagram for explaining a method for calculating a risk score.

FIG. 11 is a diagram for explaining a relationship between a risk score and an encryption range.

FIG. 12 is a diagram for explaining a flow of a process when a terminal is added to a new network (part 1).

FIG. 13 is a diagram for explaining the flow of the process when the terminal is added to the new network (part 2).

FIG. 14 is a diagram for explaining the flow of the process when the terminal is added to the new network (part 3).

FIG. 15 is a diagram for explaining a flow of a process when an encryption range of a packet is changed (part 1).

FIG. 16 is a diagram for explaining the flow of the process when the encryption range of the packet is changed (part 2).

FIG. 17 is a block diagram illustrating an example configuration of a communication apparatus in accordance with a third example embodiment of the present invention.

FIG. 18 is a block diagram illustrating a configuration of a computer that functions as the communication control apparatus and the communication apparatus in accordance with each example embodiment.

### EXAMPLE EMBODIMENTS

### First Example Embodiment

### Background of Present Invention

The Open Systems Interconnection (OSI) reference model, which has been formulated by the International Organization for Standardization (ISO) and which divides the communication functions of computers into a hierarchical structure, defines the communication functions (communications protocols) in seven different levels (layers).

The headers of communication packets are added in correspondence with the layers, and mainly include the Media Access Control (MAC) header, the Internet Protocol (IP) header, and the Transmission Control Protocol/User Datagram Protocol (TCP/UDP) header.

Each layer inherently contains security risks. For example, the MAC header includes information such as the transmission source MAC address and the transmission destination MAC address, and may be exploited for spoofing, user identification, and the like.

In addition, the IP header includes information such as the transmission source IP address and the transmission destination IP address, and may be exploited for spoofing, user identification, and the like. Furthermore, the TCP/UDP header includes information such as the transmission source port number and the transmission destination port number, and may be exploited to identify user information (such as the type of server). Furthermore, the data portion may lead to the leakage of exchanged information.

Since security risks thus exist in each region of the communication packet, increasing the encryption range can enhance the security level. However, increasing the encryption range leads to a decrease in throughput. For example, when destination information such as MAC addresses and IP addresses are to be encrypted, the following processes need to be performed at relay apparatuses such as access points, switches, and routers:
For confirming the destination of the packet, it is necessary to decrypt the encrypted destination of the received packet and then re-encrypt the destination before transmitting the packet.
It is necessary to add a new frame for the destination.
If the destination of the packet is unclear, it is necessary to perform broadcasting and it is necessary for a terminal to receive only the packet addressed to the terminal itself.

In addition, when the encryption range in a communication packet is increased, it is necessary to generate a random number in correspondence with each region. Therefore, depending on the speed of random number generation, increasing the encryption range may further decrease throughput.

An example aspect of the present invention suitably controls the encryption range of a communication packet according to the required security level while suppressing a decrease in throughput.

<Communication Control Apparatus 1 in Accordance with First Example Embodiment>

A first example embodiment of the present invention will be discussed in detail with reference to the drawings. The first example embodiment is a basic form of example embodiments discussed later. It should be noted that reference signs which are indicated in the drawings and are used in this overview are given to elements for convenience as an example for assisting in understanding, and are not intended to limit the present invention to the illustrated aspects. The lines connecting the blocks in the drawings and the like referred to in the descriptions below include both bidirectional lines and unidirectional lines. The unidirectional arrows schematically illustrate the flow of a main signal (data) and is not intended to exclude bidirectionality. Although each block in the drawings may be configured to have ports or interfaces at the input and output connection points thereof, these configurations are not illustrated.

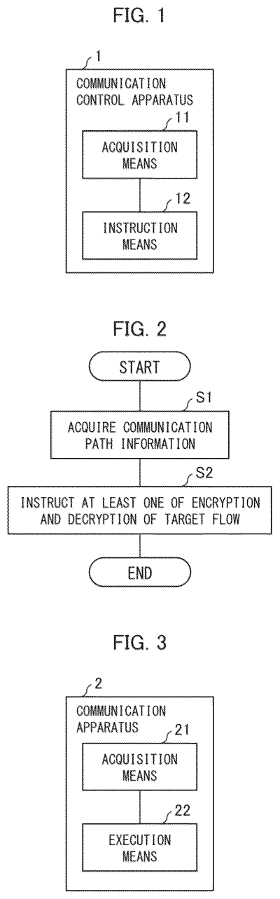

FIG. 1 is a block diagram illustrating an example configuration of a communication control apparatus 1 in accordance with the first example embodiment of the present invention. As illustrated in FIG. 1, the communication control apparatus 1 in accordance with the present example embodiment includes an acquisition means 11 and an instruction means 12.

The communication control apparatus 1 is, for example, a controller that controls a relay apparatus such as an access point, a switch, or a router. The communication control apparatus 1 mainly performs, for example, acquiring of communication path information from each relay apparatus and providing of instructions for encryption and decryption to each relay apparatus and each adapter.

The acquisition means 11 acquires communication path information. The communication path information is information pertaining to each communication path in a communication flow and is, for example, information obtained by quantifying, into a trust score, a degree of reliability of each communication path.

The communication flow is a communication path from one terminal (transmission source) to another terminal (transmission destination). If there are a plurality of relay apparatuses between the terminals, the paths between the relay apparatuses each form a single communication path. In addition, a path between a relay apparatus and an adapter connected a terminal also forms a single communication path. Therefore, if a relay apparatus exists between terminals, a plurality of communication paths are included in the communication flow.

The trust score of a communication path can be decided by, for example, the type of communication medium of the communication path. If the communication medium is wired, a high value is set as the trust score. If the communication medium is wireless, a low value is set as the trust score.

The trust score of a communication path can also be decided by information pertaining to the LAN (Local Area Network) to which the communication path belongs. The trust score of a communication path can also be decided by the presence/absence of suspicious traffic. In this case, a high value is set as the trust score for a communication path without suspicious traffic while a low value is set as the trust score for a communication path with suspicious traffic.

The instruction means 12 instructs at least one of encryption and decryption of a target flow with use of an encryption range which is defined according to the acquired communication path information and which is of the target flow. Specifically, the trust score of each communication path in the target flow is referred to and the risk score, which indicates the degree of risk of the target flow is calculated. When the risk score is low (when the degree of reliability is high), a narrow encryption range is set. When the risk score is high (when the degree of reliability is low), a wide encryption range is set.

For example, if a packet includes data, a first header, a second header, and a third header, different encryption ranges can be set, for example, as follows: (1) the encryption range is set to only the data and the first header, (2) the encryption range is set to the data, the first header, and the second header, and (3) the encryption range is set to the data, the first header, the second header, and the third header.

The instruction means 12 then provides, to relay apparatuses and adapters which are present in the communication paths in the target flow, an instruction for at least one of encryption and decryption of a communication packet with use of the encryption range of the target flow. Therefore, when there are a plurality of communication flows from terminal to terminal, different encryption ranges may be set for the communication flows.

### <Example Advantage of Communication Control Apparatus 1>

According to the communication control apparatus 1 in accordance with the present example embodiment, as discussed above, the instruction means 12 instructs at least one of encryption and decryption of the target flow with use of an encryption range which is defined according to communication path information. It is therefore possible to suitably instruct encryption or decryption of information according to the security level.

### <Flow of Communication Control Method Carried Out by Communication Control Apparatus 1>

With reference to FIG. 2, a flow of a communication control method carried out by the communication control apparatus 1 configured as discussed above will be discussed. FIG. 2 is a flowchart illustrating the flow of the communication control method. As illustrated in FIG. 2, the communication control method includes steps S1 and S2.

First, the acquisition means 11 acquires communication path information (S1). The communication path information is information pertaining to each communication path in a communication flow and is, for example, information obtained by quantifying, into a trust score, a degree of reliability of each communication path.

Next, the instruction means 12 instructs at least one of encryption and decryption of a target flow with use of an encryption range which is defined according to the acquired communication path information and which is of the target flow (S2). Specifically, the instruction means 12 provides, to the relay apparatuses which are present in the communication paths in the target flow, an instruction for at least one of encryption and decryption of a communication packet with use of the encryption range of the target flow.

### <Example Advantage of Communication Control Method>

According to the communication control method in accordance with the present example embodiment, as discussed above, the instruction means 12 instructs at least one of encryption and decryption of the target flow with use of an encryption range which is defined according to communication path information. It is therefore possible to suitably instruct encryption or decryption of information according to the security level.

### <Configuration of Communication Apparatus 2>

FIG. 3 is a block diagram illustrating an example configuration of a communication apparatus 2 in accordance with the first example embodiment of the present invention. As illustrated in FIG. 3, the communication apparatus 2 in accordance with the present example embodiment includes an acquisition means 21 and an execution means 22.

The communication apparatus 2 is a relay apparatus such as an access point, a switch, or a router. The communication apparatus 2 mainly performs, for example, acquiring of communication path information on each communication path and encrypting and decrypting of information within an encryption range instructed by the communication control apparatus 1.

The acquisition means 21 acquires communication path information. The communication path information is information pertaining to each communication path in a communication flow and is, for example, information obtained by quantifying, into a trust score, a degree of reliability of each communication path.

The execution means 22 executes at least one of encryption and decryption of a target flow with use of an encryption range which is defined according to the acquired communication path information and which is of the target flow. Specifically, the execution means 22 uses the encryption range instructed by the communication control apparatus 1, so as to execute at least one of encryption and decryption of a communication packet.

### <Example Advantage of Communication Apparatus 2>

According to the communication apparatus 2 in accordance with the present example embodiment, as discussed above, the execution means 22 executes at least one of encryption and decryption of the target flow with use of an encryption range which is defined according to communication path information. It is therefore possible to suitably encrypt or decrypt information according to the security level.

### <Flow of Communication Control Method Carried Out by Communication Apparatus 2>

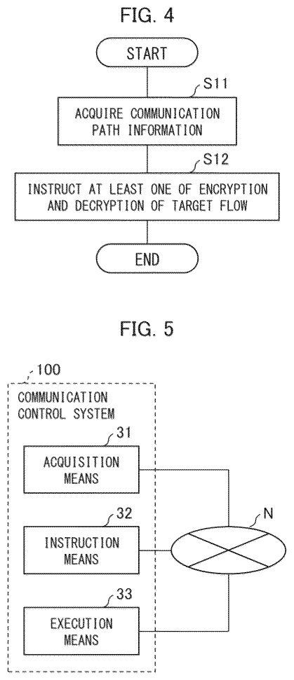

With reference to FIG. 4, a flow of the communication control method carried out by the communication apparatus 2 will be discussed. FIG. 4 is a flowchart illustrating the flow of the communication control method. As illustrated in FIG. 4, the communication control method includes steps S11 and S12.

First, the acquisition means 21 acquires communication path information (S11). The communication path information is information pertaining to each communication path in a communication flow and is, for example, information obtained by quantifying, into a trust score, a degree of reliability of each communication path.

Next, the execution means 22 executes at least one of encryption and decryption of a target flow with use of an encryption range which is defined according to the acquired communication path information and which is of the target flow (S12). Specifically, the execution means 22 uses the encryption range instructed by the communication control apparatus 1, so as to execute at least one of encryption and decryption of a communication packet.

### <Example Advantage of Communication Control Method Carried Out by Communication Apparatus 2>

According to the communication control method in accordance with the present example embodiment, as discussed above, the execution means 22 executes at least one of encryption and decryption of the target flow with use of an encryption range which is defined according to communication path information. It is therefore possible to suitably encrypt or decrypt information according to the security level.

### <Configuration of Communication Control System 100>

As illustrated in FIG. 5, a communication control system 100 in accordance with present example embodiment includes an acquisition means 31, an instruction means 32, and an execution means 33. The acquisition means 31, the instruction means 32, and the execution means 33 are configured to be able to communicate via, for example, a network N. It should be noted here that a specific configuration of the network N is not limited to the present example embodiment. Examples of the network N include a wireless LAN, a wired LAN, a WAN, a public network, a mobile data communication network, and a combination of these networks.

The functions of the communication control system 100 may be implemented on the cloud. For example, the acquisition means 31 and the instruction means 32 may be a single apparatus, and the execution means 33 may be a single apparatus. These functions may be implemented in a single apparatus or separate apparatuses. For example, if these functions are implemented in separate apparatuses, information of each section is transmitted and received via the network N and a process proceeds.

The acquisition means 31 acquires communication path information. The communication path information is information pertaining to each communication path in a communication flow and is, for example, information obtained by quantifying, into a trust score, a degree of reliability of each communication path.

The instruction means 32 instructs at least one of encryption and decryption of a target flow with use of an encryption range which is defined according to the acquired communication path information and which is of the target flow.

The execution means 33 executes at least one of encryption and decryption of a target flow with use of an encryption range which is defined according to the acquired communication path information and which is of the target flow.

### <Example Advantage of Communication Control System 100>

According to the communication control system 100 in accordance with present example embodiment, as discussed above, the instruction means 32 instructs at least one of encryption and decryption of the target flow with use of an encryption range which is defined according to communication path information. It is therefore possible to suitably instruct encryption or decryption of information according to the security level.

In addition, the execution means 33 executes at least one of encryption and decryption of the target flow with use of an encryption range which is defined according to communication path information. It is therefore possible to suitably encrypt or decrypt information according to the security level.

### Second Example Embodiment

The following description will discuss a second example embodiment of the present invention in detail with reference to the drawings. The same reference numerals are given to constituent elements which have functions identical with those discussed in the first example embodiment, and descriptions as to such constituent elements are omitted as appropriate.

<Example Configuration of Communication Control Apparatus 1A in Accordance with Second Example Embodiment>

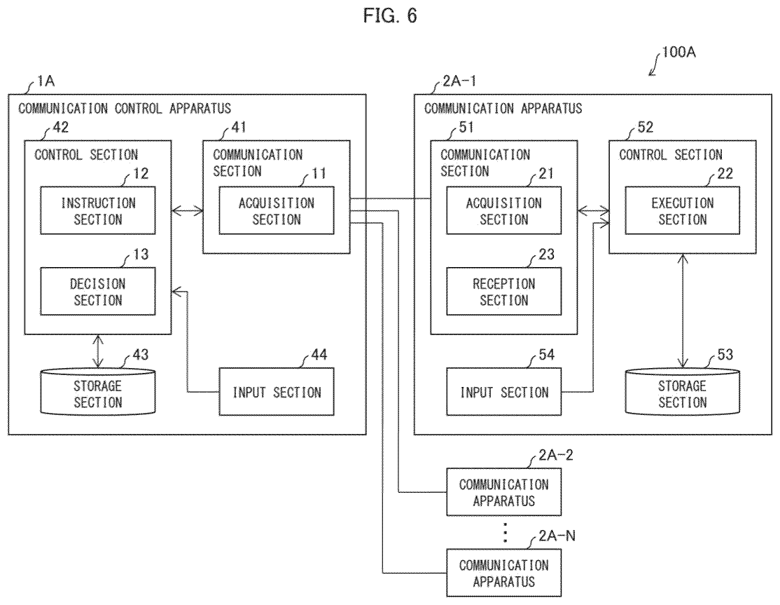

FIG. 6 is a diagram illustrating a configuration of a communication control system 100A that includes the communication control apparatus 1A and the communication apparatuses 2A in accordance with the second example embodiment of the present invention. The communication control system 100A in accordance with present example embodiment includes the communication control apparatus 1A and the communication apparatuses 2A-1 through 2A-N. As illustrated in FIG. 6, the communication control apparatus 1A includes a communication section 41, a control section 42, a storage section 43, and an input section 44.

The communication section 41 transmits/receives information to/from the communication apparatuses 2A-1 through 2A-N. The communication section 41 includes an acquisition section 11. The acquisition section 11 is a component that achieves an acquisition means in the present example embodiment.

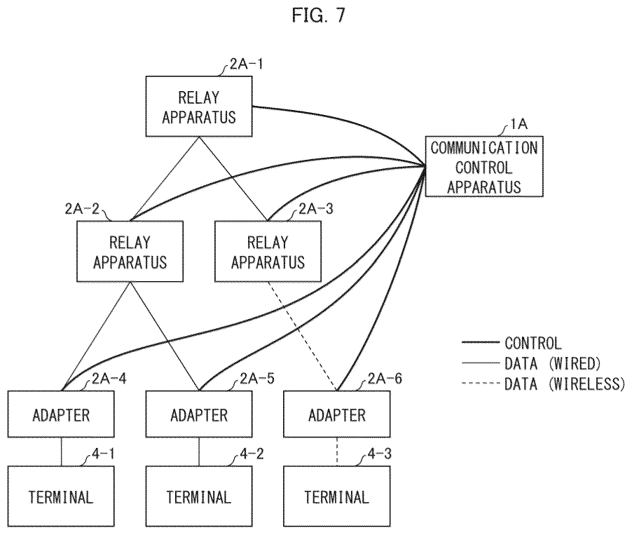

FIG. 7 is a diagram schematically illustrating connections between the communication control apparatus 1A and the communication apparatuses 2A in accordance with the second example embodiment of the present invention. The communication apparatuses 2A-1 through 2A-N illustrated in FIG. 6 correspond to relay apparatuses 2A-1 through 2A-3 such as an access point, a switch, or a router and adapters 2A-4 through 2A-6 which are illustrated in FIG. 7. Terminals 4-1 through 4-3 are connected to the adapters 2A-4 through 2A-6, respectively. It should be noted that FIG. 7 schematically shows that the communication control apparatus 1A controls the relay apparatuses 2A-1 through 2A-3 and the adapters 2A-4 through 2A-6. However, in practice, the communication control apparatus 1A controls the relay apparatuses 2A-1 through 2A-3 and the adapters 2A-4 through 2A-6 by transmitting and receiving information via the communication section 41.

The adapters 2A-4 through 2A-6 encrypt communication packets from the terminals 4-1 through 4-3 and transmit the communication packets to the relay apparatus 2A-2 or 2A-3. In addition, the adapters 2A-4 through 2A-6 decrypt communication packets received from the relay apparatus 2A-2 or 2A-3 and output the communication packets to the terminals 4-1 through 4-3.

The relay apparatuses 2A-1 through 2A-3 decrypt the received communication packets, confirm the destinations, encrypt the communication packets again, and then transmit the communication packets. In addition, the relay apparatuses 2A-1 through 2A-3 acquire communication path information of communication paths and provide notification to the communication control apparatus 1A.

The acquisition section 11 acquires the communication path information from the communication apparatuses 2A-1 through 2A-N. The communication path information is information pertaining to each communication path in a communication flow and is, for example, information obtained by quantifying, into a trust score, a degree of reliability of each communication path.

The control section 42 is a part that performs overall control of the communication control apparatus 1A, and includes an instruction section 12 and a decision section 13. The instruction section 12 is a component that achieves the instruction means in the present example embodiment. The decision section 13 is a component that achieves the decision means in the present example embodiment.

The control section 42 periodically causes the acquisition section 11 to acquire the communication path information from the communication apparatuses 2A-1 through 2A-N and stores the acquired communication path information in the storage section 43.

The decision section 13 refers to the communication path information on each communication path in the target flow which is stored in the storage section 43 and decides an encryption range of the target flow. Specifically, the communication path information is information obtained by quantifying, into a trust score, a degree of reliability of each communication path in the target flow, and the decision section 13 calculates a risk score of the target flow from the trust score of each communication path in the target flow which is stored in the storage section 43, and decides an encryption range of the target flow according to the risk score.

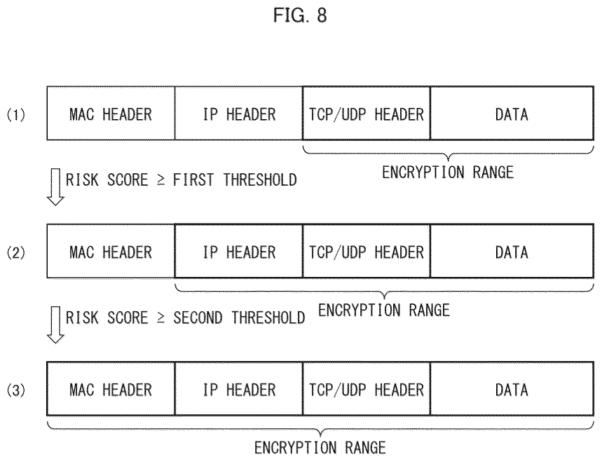

FIG. 8 is a diagram illustrating an example of an encryption range of a packet. (1) in FIG. 8 shows a case where the risk score is equal to or less than a first threshold, and the encryption range is set only to the data and the TCP/UDP header of the communication packet. Although the encryption range is set to the data and the TCP/UDP header in their entirety in (1) in FIG. 8, it is possible to, for example, set the encryption range only to part of the data and the transmission source port number of the TCP/UDP header or set the encryption range only to part of the data and the transmission destination port number of the TCP/UDP header. In addition, the encryption range may be set to part of the data and part of the TCP/UDP header and periodically change the encryption range, so as to improve the security level.

(2) in FIG. 8 shows a case where the risk score is equal to or more than the first threshold and equal to or less than a second threshold, and the encryption range is set to the data, the TCP/UDP header, and the IP header of the communication packet. As in the case of the TCP/UDP header, the encryption range may be set only to the transmission source IP address of the IP header or only to the transmission destination IP address of the IP header.

(3) in FIG. 8 shows a case where the risk score is equal to or more than the second threshold, and the encryption range is set to the data, the TCP/UDP header, the IP header, and the MAC header of the communication packet. As in the cases of the TCP/UDP header and the IP header, the encryption range may be set only to the transmission source MAC address of the MAC header or only to the transmission destination MAC address of the MAC header.

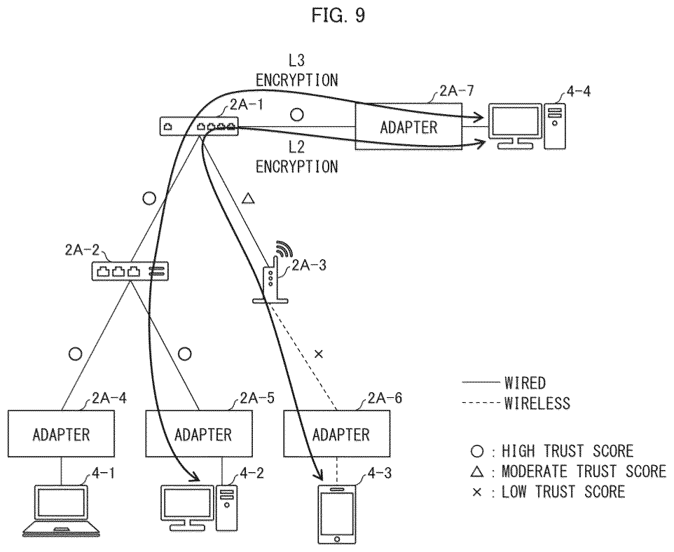

FIG. 9 is a diagram schematically illustrating a trust score between the communication apparatuses. The relay apparatus 2A-1 is an L3 switch and has the function of routing only TCP/IP at the layer 3 (network layer). The relay apparatus 2A-2 is an L2 switch and has the function of routing multiple protocols including the layer 2 (data link layer).

The relay apparatus 2A-3 is an access point and communicates with the adapter 2A-6 wirelessly. FIG. 9 shows that the trust score of the communication path between the access point 2A-3 and the adapter 2A-6 is low, and the trust score of the communication path between the L3 switch 2A-1 and the access point 2A-3 is moderate. It is shown that the trust scores of the other communication paths are high.

As illustrated in FIG. 9, in the communication flow from the terminal 4-2 to the adapter 2A-5 to the L2 switch 2A-2 to the L3 switch 2A-1 to the adapter 2A-7 to the terminal 4-4, the risk score calculated from the trust scores is low. Therefore, the encryption range is set up to the IP header corresponding to L3. In the communication flow from the terminal 4-3 to the adapter 2A-6 to the access point 2A-3 to the L3 switch 2A-1 to the adapter 2A-7 to the terminal 4-4, the risk score calculated from the trust scores is high. Therefore, the encryption range is set up to the MAC header corresponding to L2.

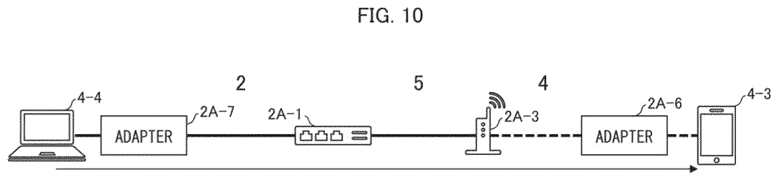

FIG. 10 is a diagram for explaining the method for calculating the risk score. For example, the degree of reliability of each communication path is evaluated as a trust score of 1 to 5. The trust score is set to “5” when the communication path is wired and no suspicious traffic has been detected. The trust score is set to “4” when the communication path is wireless and no suspicious traffic has been detected. The trust score is set to “2” when the communication path is wired and suspicious traffic has been detected. The trust score is set to “1” when the communication path is wireless and suspicious traffic has been detected.

As illustrated in FIG. 10, the trust score between the adapter 2A-7 and the L3 switch 2A-1 is “2”, the trust score between the L3 switch 2A-1 and the access point 2A-3 is “5”, and the trust score between the access point 2A-3 and the adapter 2A-6 is “4”. By calculating the total trust score of the communication paths included in the communication flow and taking the difference from the maximum score as the risk score of the communication flow, the risk score is determined as shown in the following formula (Formula 1):

Risk score=5×3−(2+5+4)=4 (Formula 1)

In the example of FIG. 10, the risk score is calculated for a case where the number of the communication paths is “3”. However, a larger number of communication paths tends to result in a greater risk score. Therefore, the risk score may be normalized by dividing the risk score by the number of communication paths.

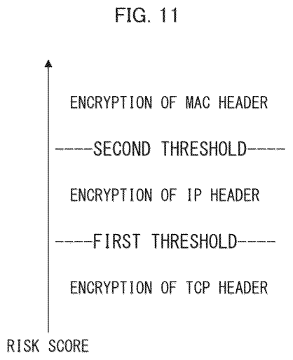

FIG. 11 is a diagram for explaining the relationship between a risk score and an encryption range. When the risk score is equal to or less than the first threshold, the decision section 13 sets the encryption range to the data and the first header of the packet which is transmitted in the target flow. For example, the first header is a TCP (/UDP) header. Alternatively, the first header may be an IP header or a MAC header.

The decision section 13 may set the encryption range to part of the data and part of the first header of the packet which is transmitted in the target flow. For example, it is possible to, for example, set the encryption range only to part of the data and the transmission source port number of the TCP/UDP header or set the encryption range only to part of the data and the transmission destination port number of the TCP/UDP header.

When the risk score is equal to or more than the first threshold and equal to or less than the second threshold, which is more than the first threshold, the decision section 13 sets the encryption range to the data, the first header, and the second header of the packet which is transmitted in the target flow. For example, the first header is a TCP/UDP header, and the second header is an IP header. Alternatively, the first header may be an IP header, and the second header may be a MAC header. Any combination of the first header and the second header can be employed.

When the risk score is equal to or more than the second threshold, the decision section 13 sets the encryption range to the data, the first header, the second header, and the third header of the packet which is transmitted in the target flow. For example, the first header is a TCP/UDP header, the second header is an IP header, and the third header is a MAC header.

The communication path information is information that has been quantified according to the communication medium of each communication path in the target flow. For example, when the communication medium of the communication path is wired, a high value is set as the trust score which is the communication path information, and, when the communication medium is wireless, a low value is set as the trust score which is the communication path information.

The communication path information is also information that has been quantified according to the presence of suspicious traffic on each communication path of the target flow. For example, for a communication path without suspicious traffic, a high value is set as the trust score which is the communication path information, and, for a communication path with suspicious traffic, a low value is set as the trust score which is the communication path information.

Here, FIG. 6 will be further discussed. The instruction section 12 provides, to the relay apparatuses and the adapters which are present in the communication paths in the target flow, an instruction for at least one of encryption and decryption of the communication packet with use of the encryption range which has been decided by the decision section 13. At this time, the instruction section 12 generates random numbers corresponding to the regions of the encryption range and then transmits the random numbers to the relay apparatuses and the adapters which are present in the communication paths in the target flow.

For example, if the encryption range includes the data, the TCP/UDP header, and the IP header, the instructions section 12 generates a random number corresponding to the data, a random number corresponding to the TCP/UDP header, and a random number corresponding to the IP header, and then transmits the three random numbers to the relay apparatuses and the adapters which are present in the communication paths in the target flow to instruct at least one of encryption and decryption of the communication packet.

The instruction section 12 may generate random numbers corresponding to the regions of the encryption range and transmit the random numbers to the relay apparatuses and the adapters which are present in the communication paths in the target flow, in such a manner as to periodically update the random numbers.

The input section 44 is constituted by, for example, a switch and is used for, for example, setting a mode of the communication control apparatus 1A. The control section 42 acquires a value set in the input section 44 and performs setting, changing, or the like of, for example, an operation mode.

<Example Configuration of Communication Apparatuses 2A in Accordance with Second Example Embodiment>

As illustrated in FIG. 6, the communication apparatus 2A-1 includes a communication section 51, a control section 52, a storage section 53, and an input section 54. The communication section 51 transmits/receives information to/from the communication control apparatus 1A. The communication section 51 includes an acquisition section 21 and a reception section 23. The acquisition section 21 is a component that achieves an acquisition means in the present example embodiment. The reception section 23 is a component that achieves a reception means in the present example embodiment.

The acquisition section 21 acquires communication path information. The communication section 51 transmits, to the communication control apparatus 1A, the communication path information which has been acquired by the acquisition section 21. The communication path information is information pertaining to each communication path in a communication flow and is, for example, information obtained by quantifying, into a trust score, a degree of reliability of each communication path.

The reception section 23 receives, from the communication control apparatus 1A that controls the communication apparatuses 2A-1 through 2A-N, an encryption range of the target flow, and stores the encryption range in the storage section 53. The reception section 23 receives, from the communication control apparatus 1A, random numbers corresponding to the regions of the encryption range, and stores the random numbers in the storage section 53.

The control section 52 is a part that performs overall control of the communication apparatus 2A-1, and includes an execution section 22. The execution section 22 is a component that achieves an execution means in the present example embodiment. The execution section 22 executes at least one of encryption and decryption of the target flow with use of the encryption range of the target flow which is stored in the storage section 53. At this time, the random numbers which correspond to the regions of the encryption range and which are stored in the storage section 53 are used.

The input section 54 is constituted by, for example, a switch and is used for, for example, setting a mode of the communication apparatus 2A-1. The control section 52 acquires a value set in the input section 54 and performs setting, changing, or the like of, for example, an operation mode.

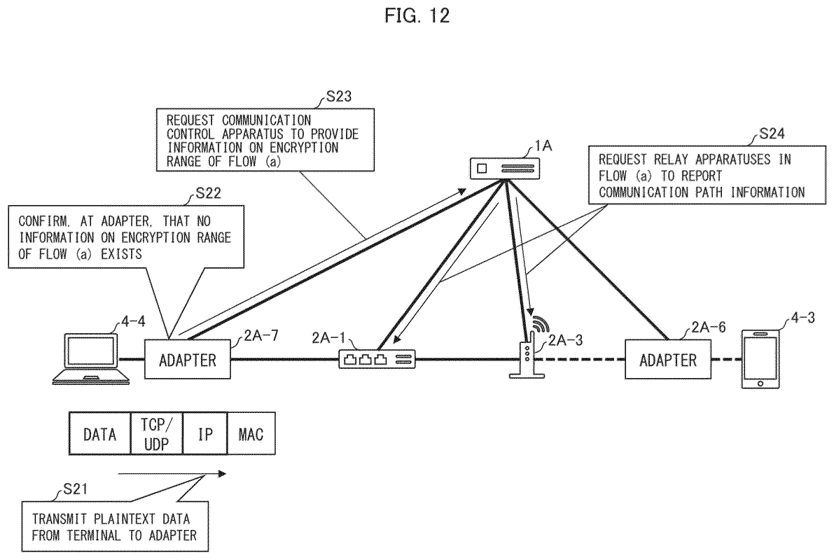

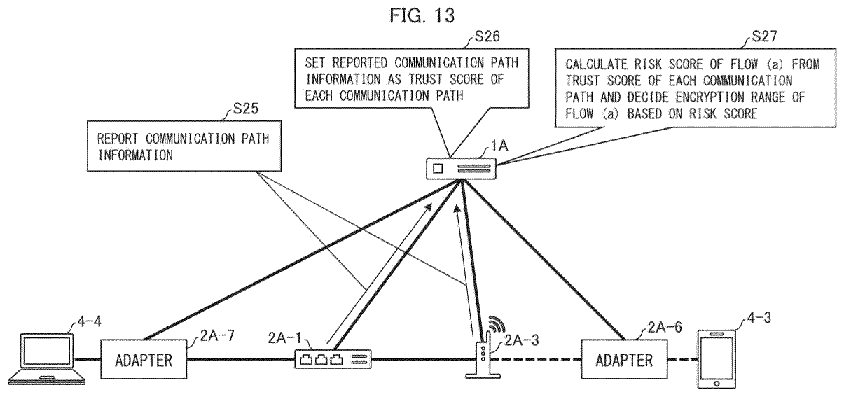

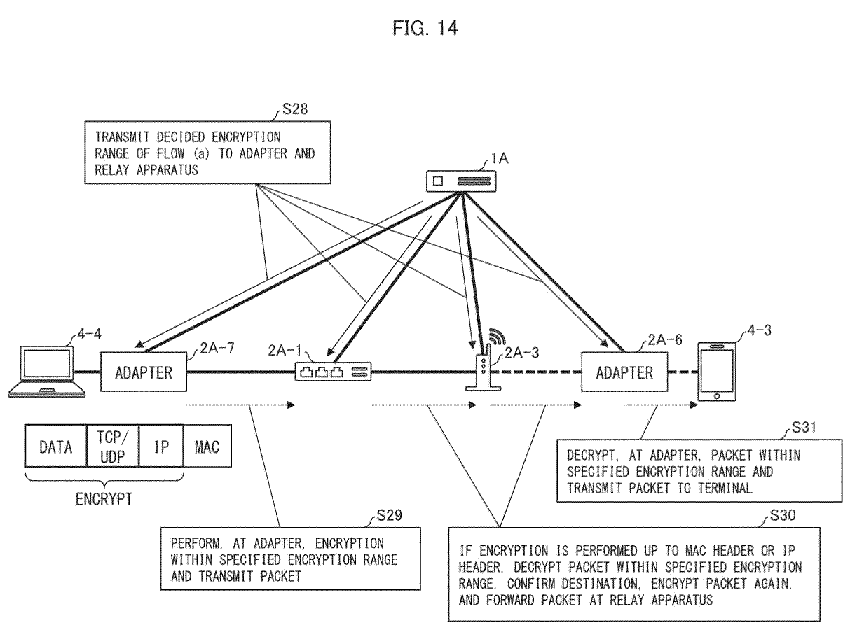

FIGS. 12 through 14 are diagrams for explaining a flow of a process when a terminal is added to a network. First, a plaintext data packet is transmitted from the terminal 4-4 to the adapter 2A-7 (S21). Next, the adapter 2A-7 confirms that no information on an encryption range of a flow (a) exists (S22). It should be noted that the flow (a) is a communication flow from the terminal 4-4 to the adapter 2A-7 to the L3 switch 2A-1 to the access point 2A-3 to the adapter 2A-6.

Next, the adapter 2A-7 requests the communication control apparatus 1A to provide information on the encryption range of the flow (a) (S23). When the communication section 41 of the communication control apparatus 1A has received, from the adapter 2A-7, the request for the encryption range, the acquisition section 11 of the communication control apparatus 1A requests the relay apparatuses 2A-1 and 2A-3 in the flow (a) to provide a report on the communication path information (S24).

Next, when the relay apparatuses 2A-1 and 2A-3 have provided a report on the communication path information to the communication control apparatus 1A (S25), the decision section 13 of the communication control apparatus 1A sets the reported communication path information as a trust score of each communication path (S26). Then, the decision section 13 of the communication control apparatus 1A calculates a risk score of the flow (a) from the trust score of each communication path and, based on the risk score, decides the encryption range of the flow (a) (S27).

Next, the communication section 41 of the communication control apparatus 1A transmits the encryption range of the flow (a) decided by the decision section 13 to the adapter 2A-7, the L3 switch 2A-1, the access point 2A-3, and the adapter 2A-6 (S28).

The adapter 2A-7 encrypts the packet within the encryption range specified by the communication control apparatus 1A, and transmits the packet to the L3 switch 2A-1 (S29). When the L3 switch 2A-1 has received the packet from the adapter 2A-7, if the encryption range extends up to the MAC header or the IP header, the L3 switch 2A-1 decrypts the packet within the encryption range instructed by the communication control apparatus 1A, confirms the destination, encrypts the packet again, and then transmits the packet to the access point 2A-3.

Similarly, when the access point 2A-3 has received the packet from the L3 switch 2A-1, if the encryption range extends up to the MAC header or the IP header, the access point 2A-3 decrypts the packet within the encryption range instructed by the communication control apparatus 1A, confirms the destination, encrypts the packet again, and then transmits the packet to the adapter 2A-6 (S30).

Finally, the adapter 2A-6 decrypts the packet received from the access point 2A-3 within the encryption range instructed by the communication control apparatus 1A and transmits the packet to the terminal 4-3 (S31). This completes the process.

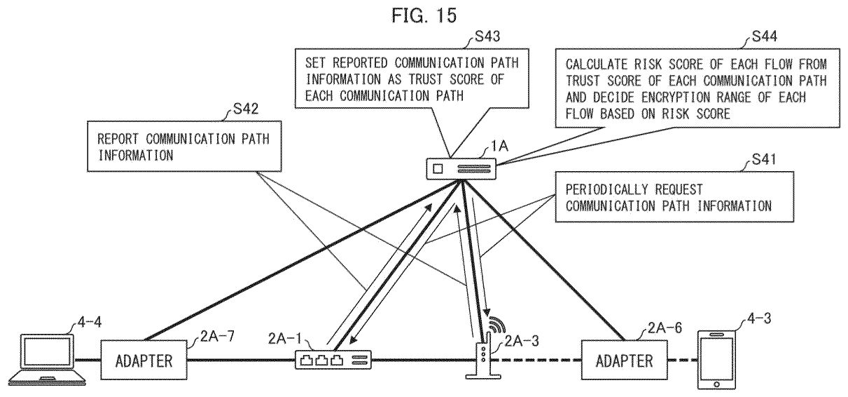

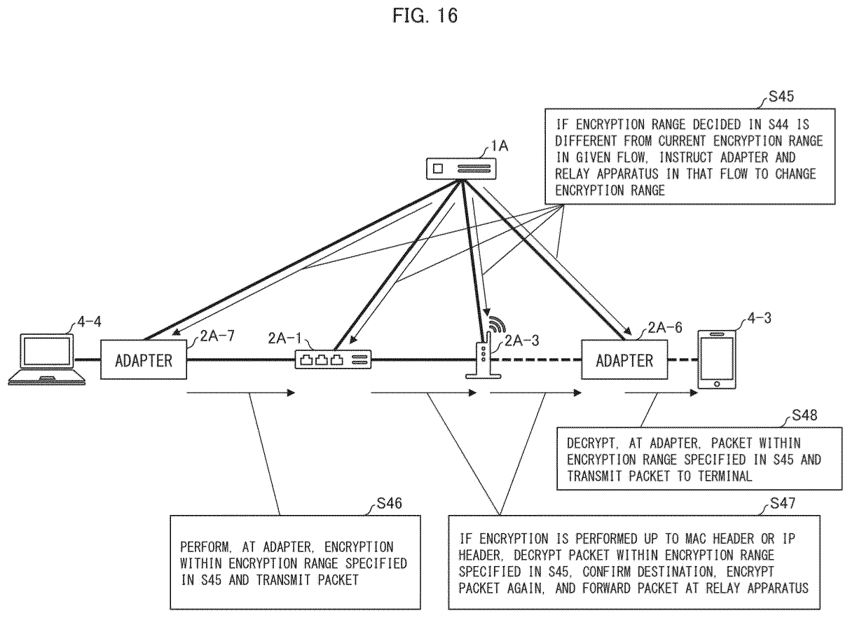

FIGS. 15 and 16 are diagrams for explaining a flow of a process when the encryption range of a packet is changed. The communication control apparatus 1A periodically requests the L3 switch 2A-1 and the access point 2A-3 to provide communication path information (S41).

When the L3 switch 2A-1 and the access point 2A-3 have provided a report on the communication path information to the communication control apparatus 1A (S42), the decision section 13 of the communication control apparatus 1A sets the reported communication path information as a trust score of each communication path (S43).

Next, the decision section 13 of the communication control apparatus 1A calculates a risk score of each flow from the trust scores and, based on the risk score, decides an encryption range of each flow (S44). The decision section 13 of the communication control apparatus 1A compares the current encryption range of each flow stored in the storage section 43 with the encryption range of each flow calculated in the step S44. For a flow for which the encryption ranges are different, the instruction section 12 instructs the relay apparatus and the adapter in the flow to change the encryption range (S45). For example, if the encryption range of the flow (a) is to be changed, the instruction section 12 instructs the adapter 2A-7, the L3 switch 2A-1, the access point 2A-3, and the adapter 2A-6 to change the encryption range.

The adapter 2A-7 encrypts the packet received from the terminal 4-4 within the encryption range specified in the step S45 and then transmits the packet to the L3 switch 2A-1 (S46). When the L3 switch 2A-1 has received the packet from the adapter 2A-7, if the encryption range extends up to the MAC header or the IP header, the L3 switch 2A-1 decrypts the packet within the encryption range instructed by the communication control apparatus 1A, confirms the destination, encrypts the packet again, and then transmits the packet to the access point 2A-3.

Similarly, when the access point 2A-3 has received the packet from the L3 switch 2A-1, if the encryption range extends up to the MAC header or the IP header, the access point 2A-3 decrypts the packet within the encryption range instructed by the communication control apparatus 1A, confirms the destination, encrypts the packet again, and then transmits the packet to the adapter 2A-6 (S47).

Finally, the adapter 2A-6 decrypts the packet received from the access point 2A-3 within the encryption range instructed by the communication control apparatus 1A and transmits the packet to the terminal 4-3 (S48). This completes the process.

### <Example Advantages of Communication Control System 100A>

As discussed above, according to the communication control apparatus 1A in accordance with the present example embodiment, the decision section 13 refers to communication path information on each communication path in a target flow and decides an encryption range of the target flow. Therefore, it is possible to suitably decide an encryption range of the target flow according to the security level.

In addition, since the decision section 13 of the communication control apparatus 1A decides the encryption range of the target flow according to a risk score, it is possible to suitably decide the encryption range of the target flow according to the risk score.

When the risk score is low, the decision section 13 of the communication control apparatus 1A can set the encryption range only to the data and the first header of the packet.

In addition, the decision section 13 of the communication control apparatus 1A can reduce the processing load on the communication apparatus by setting the encryption range only to part of the data and part of the header of the packet.

When the risk score is moderate, the decision section 13 of the communication control apparatus 1A can set the encryption range to the data, the first header, and the second header of the packet.

When the risk score is high, the decision section 13 of the communication control apparatus 1A can set the encryption range to the data, the first header, the second header, and the third header of the packet.

In addition, because the communication path information is information that has been quantified according to the communication medium of each communication path in the target flow, the decision section 13 of the communication control apparatus 1A can set a high trust score as the communication path information for wired communication and set a low trust score as the communication path information for wireless communication.

In addition, because the communication path information is information that has been quantified according to the presence of suspicious traffic on each communication path in the target flow, the decision section 13 of the communication control apparatus 1A can set a high trust score as the communication path information for a communication path without suspicious traffic and set a low trust score as the communication path information for a communication path with suspicious traffic.

In addition, the execution section 22 of the communication apparatuses 2A can encrypt or decrypt information according to the encryption range received from the communication control apparatus 1A.

### Third Example Embodiment

The following description will discuss a third example embodiment of the present invention in detail with reference to the drawings. The same reference numerals are given to constituent elements which have functions identical with those discussed in the first and second example embodiments, and descriptions as to such constituent elements are omitted as appropriate. It should be noted that in the present example embodiment, no communication control apparatus exists, and a communication apparatus itself decides an encryption range and performs encryption and decryption of information.

<Example Configuration of Communication Apparatus 2B in Accordance with Third Example Embodiment>

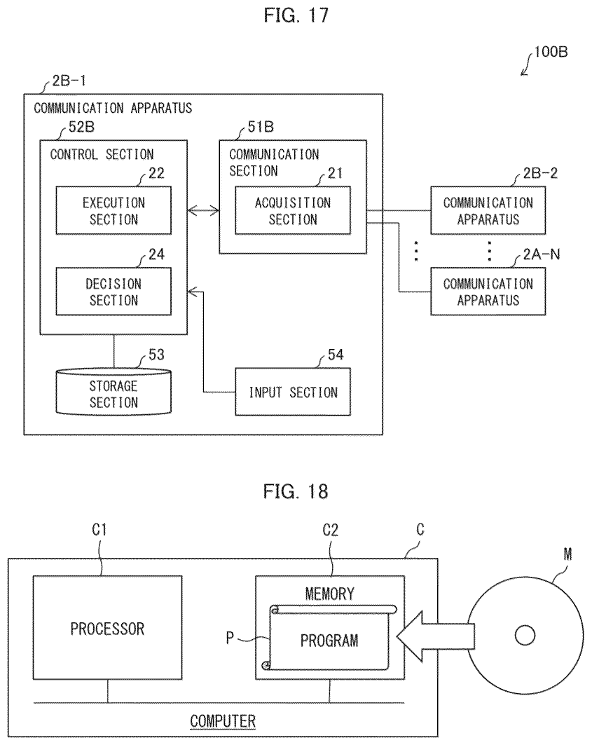

FIG. 17 is a diagram illustrating a configuration of a communication control system 100B that includes a communication apparatus 2B in accordance with the third example embodiment of the present invention. The communication control system 100B in accordance with present example embodiment includes communication apparatuses 2B-1 to 2B-N. As illustrated in FIG. 17, the communication apparatus 2B-1 includes a communication section 51B, a control section 52B, a storage section 53, and an input section 54.

The communication section 51B transmits/receives information to/from the communication apparatuses 2B-2 to 2B-N. The communication section 51B includes an acquisition section 21. The acquisition section 21 is a component that achieves an acquisition means in the present example embodiment.

The acquisition section 21 acquires communication path information. Specifically, the acquisition section 21 acquires (i) communication path information on the communication path to which the communication apparatus 2B-1 itself is connected and (ii) communication path information on other communication paths in the target flow received from the communication apparatuses 2B-2 to 2B-N. Then, the acquisition section 21 stores the acquired communication path information in the storage section 53.

The decision section 24 refers to the communication path information on each communication path in the target flow which is stored in the storage section 53 and decides an encryption range of the target flow. Specifically, the communication path information is information obtained by quantifying, into a trust score, a degree of reliability of each communication path in the target flow, and the decision section 24 calculates a risk score of the target flow from the trust score of each communication path in the target flow which is stored in the storage section 53, and decides an encryption range of the target flow according to the risk score.

The execution section 22 executes at least one of encryption and decryption of the target flow with use of the encryption range which has been decided by the decision section 24.

### <Example Advantage of Communication Control System 100B>

As discussed above, according to the communication apparatus 2B in accordance with the present example embodiment, the decision section 24 refers to communication path information on each communication path in a target flow and decides an encryption range of the target flow. Therefore, it is possible to suitably decide an encryption range of the target flow according to the security level.

### [Software Implementation Example]

The functions of part of or all of the communication control apparatuses 1 and 1A, the communication apparatuses 2, 2A, and 2B, and the communication control systems 100, 100A, and 100B can be realized by hardware such as an integrated circuit (IC chip) or can be alternatively realized by software.

In the latter case, each of the communication control apparatuses 1 and 1A, the communication apparatuses 2, 2A, and 2B, and the communication control systems 100, 100A, and 100B is realized by, for example, a computer that executes instructions of a program that is software realizing the foregoing functions. FIG. 9 illustrates an example of such a computer (hereinafter referred to as “computer C”). The computer C includes at least one processor C1 and at least one memory C2. The memory C2 stores a program P for causing the computer C to function as the communication control apparatuses 1 and 1A, the communication apparatuses 2, 2A, and 2B, and the communication control systems 100, 100A, and 100B. In the computer C, the processor C1 reads the program P from the memory C2 and executes the program P, so that the functions of the communication control apparatuses 1 and 1A, the communication apparatuses 2, 2A, and 2B, and the communication control systems 100, 100A, and 100B are realized.

As the processor C1, for example, it is possible to use a central processing unit (CPU), a graphic processing unit (GPU), a digital signal processor (DSP), a micro processing unit (MPU), a floating point number processing unit (FPU), a physics processing unit (PPU), a microcontroller, or a combination of these. The memory C2 can be, for example, a flash memory, a hard disk drive (HDD), a solid state drive (SSD), or a combination of these.

The computer C may further include a RAM in which the program P is loaded when executed and/or in which various kinds of data are temporarily stored. The computer C may further include a communication interface via which data is transmitted to and received from another apparatus. The computer C may further include an input-output interface for connecting input-output apparatuses such as a keyboard, a mouse, a display and/or a printer.

The program P can be stored in a non-transitory tangible storage medium M which is readable by the computer C. Examples of such a storage medium M can include a tape, a disk, a card, a semiconductor memory, and a programmable logic circuit. The computer C can acquire the program P via such a storage medium M. The program P can be transmitted via a transmission medium. Examples of such a transmission medium include a communication network and a broadcast wave. The computer C can also acquire the program P via such a transmission medium.

### [Additional Remark 1]

The present invention is not limited to the foregoing example embodiments, but can be altered in various ways by a skilled person within the scope of the claims. For example, the present invention also encompasses, in its technical scope, any example embodiment derived by appropriately combining technical means disclosed in the foregoing example embodiments.

### [Additional Remark 2]

Some of or all of the foregoing example embodiments can also be described as below. However, that the present invention is not limited to the example aspects described below.

### (Supplementary Note 1)

A communication control apparatus including: an acquisition means for acquiring communication path information; and an instruction means for instructing at least one of encryption and decryption of a target flow with use of an encryption range which is defined according to the communication path information acquired and which is of the target flow.

The above configurations make it possible to suitably instruct encryption or decryption of information according to the security level.

### (Supplementary Note 2)

The communication control apparatus according to the supplementary note 1, further including a decision means for referring to the communication path information on each communication path in the target flow and deciding the encryption range of the target flow.

The above configuration makes it possible to suitably decide the encryption range of the target flow according to the security level.

### (Supplementary Note 3)

The communication control apparatus according to the supplementary note 2, in which: the communication path information is information obtained by quantifying, into a trust score, a degree of reliability of each communication path in the target flow; and the decision means is configured to calculate a risk score of the target flow from the trust score of each communication path in the target flow and decide the encryption range of the target flow according to the risk score.

The above configuration makes it possible to suitably decide the encryption range of the target flow according to the risk score.

### (Supplementary Note 4)

The communication control apparatus according to the supplementary note 3, in which, when the risk score is equal to or less than a first threshold, the decision means sets the encryption range to data and a first header of a packet which is transmitted in the target flow.

The above configuration makes it possible to set the encryption range only to the data and the first header of the packet when the risk score is low.

### (Supplementary Note 5)

The communication control apparatus according to the supplementary note 4, in which the decision means sets the encryption range to part of the data and part of the first header of the packet which is transmitted in the target flow.

The above configuration makes it possible to reduce the processing load on the communication apparatus by setting the encryption range only to part of the data and part of the first header of the packet.

### (Supplementary Note 6)

The communication control apparatus according to the supplementary note 4 or 5, in which, when the risk score is equal to or more than the first threshold and equal to or less than a second threshold, which is more than the first threshold, the decision means sets the encryption range to the data, the first header, and a second header of the packet which is transmitted in the target flow.

The above configuration makes it possible to set the encryption range to the data, the first header, and the second header of the packet when the risk score is moderate.

### (Supplementary Note 7)

The communication control apparatus according to the supplementary note 6, in which, when the risk score is equal to or more than the second threshold, the decision means sets the encryption range to the data, the first header, the second header, and a third header of the packet which is transmitted in the target flow.

The above configuration makes it possible to set the encryption range to the data, the first header, the second header, and the third header of the packet when the risk score is high.

### (Supplementary Note 8)

The communication control apparatus according to any one of the supplementary notes 1 through 7, in which the communication path information is information that has been quantified according to a communication medium of each communication path in the target flow.

The above configuration makes it possible to set a high trust score as the communication path information for wired communications and set a low trust score as the communication path information for wireless communication.

### (Supplementary Note 9)

The communication control apparatus according to any one of the supplementary notes 1 through 8, in which the communication path information is information that has been quantified according to a presence of suspicious traffic on each communication path of the target flow.

The above configuration makes it possible to set a high trust score as the communication path information for a communication path without suspicious traffic and set a low trust score as the communication path information for a communication path with suspicious traffic.

### (Supplementary Note 10)

A communication apparatus including: an acquisition means for acquiring communication path information; and an execution means for executing at least one of encryption and decryption of a target flow with use of an encryption range which is defined according to the communication path information acquired and which is of the target flow.

The above configuration makes it possible to suitably execute encryption or decryption of information according to the security level.

### (Supplementary Note 11)

The communication apparatus according to the supplementary note 10, further including a decision means for referring to the communication path information on each communication path in the target flow and deciding the encryption range of the target flow.

The above configuration makes it possible to suitably decide the encryption range of the target flow according to the security level.

### (Supplementary Note 12)

The communication apparatus according to the supplementary note 10, further including a reception means for receiving the encryption range of the target flow from a communication control apparatus that controls the communication apparatus.

The above configuration makes it possible to execute encryption or decryption of information according to the encryption range received from the communication control apparatus.

### (Supplementary Note 13)

A communication control system including: an acquisition means for acquiring communication path information; an instruction means for instructing at least one of encryption and decryption of a target flow with use of an encryption range which is defined according to the communication path information acquired and which is of the target flow; and an execution means for executing at least one of encryption and decryption of the target flow with use of the encryption range of the target flow.

The above configuration makes it possible to suitably execute encryption or decryption of information according to the security level.

### (Supplementary Note 14)

A method for controlling communication, said method including: acquiring communication path information; and instructing at least one of encryption and decryption of a target flow with use of an encryption range which is defined according to the communication path information acquired and which is of the target flow.

The above configuration makes it possible to suitably instruct encryption or decryption of information according to the security level.

### (Supplementary Note 15)

A method for controlling communication, said method including: acquiring communication path information; and executing at least one of encryption and decryption of a target flow with use of an encryption range which is defined according to the communication path information acquired and which is of the target flow.

The above configuration makes it possible to suitably execute encryption or decryption of information according to the security level.

### (Supplementary Note 16)

A program for causing a computer to execute: a process of acquiring communication path information; and a process of instructing at least one of encryption and decryption of a target flow with use of an encryption range which is defined according to the communication path information acquired and which is of the target flow.

The above configuration makes it possible to suitably instruct encryption or decryption of information according to the security level.

### (Supplementary Note 17)

A program for causing a computer to execute: a process of acquiring communication path information; and a process of executing at least one of encryption and decryption of a target flow with use of an encryption range which is defined according to the communication path information acquired and which is of the target flow.

The above configuration makes it possible to suitably execute encryption or decryption of information according to the security level.

### (Supplementary Note 18)

A communication control apparatus including at least one processor, in which the processor executes: a process of acquiring communication path information; and a process of instructing at least one of encryption and decryption of a target flow with use of an encryption range which is defined according to the communication path information acquired and which is of the target flow.

It should be noted that the communication control apparatus may further include a memory. The memory may store a program for causing the processor to execute the acquisition process and the instruction process. The program may be stored in a computer-readable non-transitory tangible storage medium.

### (Supplementary Note 19)

A communication apparatus including at least one processor, in which the processor executes: a process of acquiring communication path information; and a process of executing at least one of encryption and decryption of a target flow with use of an encryption range which is defined according to the communication path information acquired and which is of the target flow.

It should be noted that the communication apparatus may further include a memory. The memory may store a program for causing the processor to execute the acquisition process and the execution process. The program may be stored in a computer-readable non-transitory tangible storage medium.

### REFERENCE SIGNS LIST

1, 1A Communication control apparatus
2, 2A, 2B Communication apparatus
11, 21 Acquisition section (acquisition means)
12 Instruction section (instruction means)
13, 24 Decision section (decision means)
22 Execution section (execution means)
23 Reception section (reception means)
31 Acquisition means
32 Instruction means
33 Execution means
41, 51, 51B Communication section
42, 52, 52B Control section
43, 53 Storage section
44, 54 Input section
100, 100A, 100B Communication control system

What is claimed is:

1. A communication control apparatus comprising:
at least one processor,
the at least one processor being configured to execute
a process of acquiring communication path information and
a process of instructing at least one of encryption and decryption of a target flow with use of an encryption range which is defined according to the communication path information acquired and which is of the target flow.

2. The communication control apparatus according to claim 1, wherein the at least one processor further executes a process of deciding the encryption range of the target flow by referring to the communication path information on each communication path in the target flow.

3. The communication control apparatus according to claim 2, wherein:
the communication path information is information obtained by quantifying, into a trust score, a degree of reliability of each communication path in the target flow; and
in the process of deciding, the at least one processor
calculates a risk score of the target flow from the trust score of each communication path in the target flow and
decides the encryption range of the target flow according to the risk score.

4. The communication control apparatus according to claim 3, wherein, in the process of deciding, when the risk score is equal to or less than a first threshold, the at least one processor sets the encryption range to data and a first header of a packet which is transmitted in the target flow.

5. The communication control apparatus according to claim 4, wherein, in the process of deciding, the at least one processor sets the encryption range to part of the data and part of the first header of the packet which is transmitted in the target flow.

6. The communication control apparatus according to claim 4, wherein, in the process of deciding, when the risk score is equal to or more than the first threshold and equal to or less than a second threshold, which is more than the first threshold, the at least one processor sets the encryption range to the data, the first header, and a second header of the packet which is transmitted in the target flow.

7. The communication control apparatus according to claim 6, wherein, in the process of deciding, when the risk score is equal to or more than the second threshold, the at least one processor sets the encryption range to the data, the first header, the second header, and a third header of the packet which is transmitted in the target flow.

8. The communication control apparatus according to claim 1, wherein the communication path information is information that has been quantified according to a communication medium of each communication path in the target flow.

9. The communication control apparatus according to claim 1, wherein the communication path information is information that has been quantified according to a presence of suspicious traffic on each communication path of the target flow.

10. A communication apparatus comprising:
at least one processor,
the at least one processor being configured to execute
a process of acquiring communication path information and
a process of executing at least one of encryption and decryption of a target flow with use of an encryption range which is defined according to the communication path information acquired and which is of the target flow.

11. The communication apparatus according to claim 10, wherein the at least one processor further executes a process of deciding the encryption range of the target flow by referring to the communication path information on each communication path in the target flow.

12. The communication apparatus according to claim 10, wherein the at least one processor further executes a process of receiving the encryption range of the target flow from a communication control apparatus that controls the communication apparatus.

13. (canceled)

14. A method for controlling communication, said method comprising:
acquiring communication path information; and
instructing at least one of encryption and decryption of a target flow with use of an encryption range which is defined according to the communication path information acquired and which is of the target flow.

15.-17. (canceled)

18. The method according to claim 14, further comprising
deciding the encryption range of the target flow by referring to the communication path information on each communication path in the target flow.

19. The method according to claim 18, wherein:
the communication path information is information obtained by quantifying, into a trust score, a degree of reliability of each communication path in the target flow; and
in the deciding,
a risk score of the target flow is calculated from the trust score of each communication path in the target flow and
the encryption range of the target flow is decided according to the risk score.

20. The method according to claim 19, wherein, in the deciding, when the risk score is equal to or less than a first threshold, the encryption range is set to data and a first header of a packet which is transmitted in the target flow.

21. The method according to claim 20, wherein, in the deciding, the encryption range is set to part of the data and part of the first header of the packet which is transmitted in the target flow.

22. The method according to claim 20, wherein, in the deciding, when the risk score is equal to or more than the first threshold and equal to or less than a second threshold, which is more than the first threshold, the encryption range is set to the data, the first header, and a second header of the packet which is transmitted in the target flow.

23. The method according to claim 22, wherein, in the deciding, when the risk score is equal to or more than the second threshold, the encryption range is set to the data, the first header, the second header, and a third header of the packet which is transmitted in the target flow.

24. The method according to claim 14, wherein the communication path information is information that has been quantified according to a communication medium of each communication path in the target flow.

25. The method according to claim 14, wherein the communication path information is information that has been quantified according to a presence of suspicious traffic on each communication path of the target flow.
